(19) United States
(12) Patent Application Publication
(10) Pub. No.: US 2020/0134762 A1
(43) Pub. Date: Apr. 30, 2020

(54) ORDER GROUP ALLOCATION METHOD AND DEVICE

(71) Applicant: BEIJING XIAODU INFORMATION TECHNOLOGY CO., LTD., Beijing (CN)

(72) Inventors: Jinqing CHEN, BEIJING (CN); Mingquan XU, BEIJING (CN); Shaojian HUANG, BEIJING (CN); Ke XIAN, BEIJING (CN); Qiuyuan YANG, BEIJING (CN); Jiajia RAO, BEIJING (CN)

(21) Appl. No.: 16/728,611

(22) Filed: Dec. 27, 2019

Related U.S. Application Data
(63) Continuation of application No. PCT/CN2017/118778, filed on Dec. 26, 2017.

(30) Foreign Application Priority Data
Jun. 29, 2017 (CN) 201710517908.3

(51) Int. Cl. G06Q 50/28; G06Q 10/06

(52) U.S. Cl. CPC G06Q 50/28; G06Q 10/06311

(57) ABSTRACT

An order group allocation method and apparatus are disclosed. The order group allocation method includes: determining, based on a matching score between each of a plurality of to-be-processed order groups and each of a plurality of delivery persons, an order group with a lowest matching score corresponding to each delivery person; dividing the to-be-processed order groups and the delivery persons into a plurality of non-intersecting sub-combinations; and allocating the to-be-processed order group based on an order group allocation process for each sub-combination, so that each to-be-processed order group in each sub-combination is allocated to a delivery person in a corresponding sub-combination. The method of the present disclosure improves order group allocation efficiency.

### CROSS-REFERENCE TO RELATED APPLICATION

This application is a continuation application of International Patent Application No. PCT/CN2017/118778, filed on Dec. 26, 2017, which is based on and claims priority to the Chinese Patent Application No. 201710517908.3, filed on Jun. 29, 2017 and entitled “ORDER GROUP ALLOCATION METHOD AND DEVICE.” The above-referenced applications are incorporated herein by reference in their entirety.

### TECHNICAL FIELD

The present disclosure relates to the field of Internet technologies, and in particular, to an order group allocation method and apparatus.

### BACKGROUND

With rapid development of Internet technologies, there are increasingly more Internet-based applications, such as take-out order applications and shopping applications. Using these applications, users can order items they need without leaving their home. These applications, while bringing convenience to the users, have the issue of order delivery. Therefore, logistics systems whose main task is to allocate new orders to an appropriate delivery persons, emerge.

Delivery by grouping is a main delivery method used by the logistics systems. A grouping allocation process is performed as follows. The logistics system first groups similar orders into groups, then calculates a score between each order group and each delivery person, and allocates each order group to an appropriate delivery person based on overall scores of a plurality of order groups and a plurality of delivery persons.

Conventionally, during order group allocation, a delivery person matching each order group is determined based on a list of scores between all order groups and all delivery persons by using a maximum weight matching operation KM algorithm. Then, the order group is allocated to the delivery person matching the order group. However, there are usually a large quantity of order groups and delivery persons, especially in case of scheduling orders covering the whole city. Consequently, the KM algorithm may requires a tremendous computational resource, and order group allocation efficiency may be adversely affected.

### SUMMARY

The present disclosure provides an order group allocation method and apparatus that improve the efficiency of order group allocation.

A first aspect of the present disclosure is directed to an order group allocation method. The method may include: determining, based on a matching score between each of a plurality of to-be-processed order groups and each of a plurality of delivery persons, a to-be-processed order group with a lowest matching score corresponding to each delivery person; dividing the to-be-processed order groups and the delivery persons into a plurality of non-intersecting sub-combinations based on the to-be-processed order group with the lowest matching score corresponding to each delivery person. The “non-intersecting” means that there is no overlapping to-be-processed order groups and no overlapping delivery persons between the sub-combinations.

The method may further include allocating the to-be-processed order group based on an order group allocation process for each sub-combination, so that each to-be-processed order group in each sub-combination is allocated to a delivery person in a corresponding sub-combination.

Optionally, the method may further include: calculating the matching score between each to-be-processed order group and each delivery person based on one or more factors of a distance between an estimated delivery location of each delivery person and a start address of each to-be-processed order group, a time difference between an estimated delivery time of each delivery person and an expected arrival time of each to-be-processed order group, a degree of familiarity with the start address of each to-be-processed order group by each delivery person, a degree of familiarity with a destination address of each to-be-processed order group by each delivery person, an estimated completion time in which each delivery person completes delivery of each to-be-processed order group, and an emergency degree of each to-be-processed order group.

Optionally, dividing the to-be-processed order groups and the delivery persons into a plurality of non-intersecting sub-combinations may include: traversing each to-be-processed order group and each delivery person using a traversal algorithm, and dividing the to-be-processed order groups and the delivery persons into a plurality of non-intersecting sub-combinations using the to-be-processed order group with the lowest matching score corresponding to each delivery person as a constraint condition. The traversal algorithm may include a breadth-first traversal algorithm or a depth-first traversal algorithm.

Optionally, traversing each to-be-processed order group and each delivery person using a traversal algorithm, and dividing the to-be-processed order groups and the delivery persons into a plurality of non-intersecting sub-combinations using the to-be-processed order group with the lowest matching score corresponding to each delivery person as a constraint condition may include: establishing a network topology by using the to-be-processed order groups and the delivery persons as nodes, with a link between each to-be-processed order group and each delivery person representing a corresponding matching score; traversing, for each node, all associated nodes of the node using a lowest matching score between the nodes as a constraint condition, determining, for each node, an associated node with a lowest matching score, and deleting, for each node, a link between the node and the associated node with the lowest matching score; and dividing the network topology into a plurality of non-intersecting sub-networks. There is no overlapping links in the plurality of non-intersecting sub-networks. The plurality of non-intersecting sub-networks are the corresponding plurality of non-intersecting sub-combinations.

Optionally, allocating the to-be-processed order group based on an order group allocation process for each sub-combination, so that each to-be-processed order group in each sub-combination is allocated to a delivery person in a corresponding sub-combination may include: for each sub-combination, performing a maximum weight matching operation on each to-be-processed order group and each delivery person to determine a delivery person with a highest matching score corresponding to each to-be-processed order group.

The maximum weight matching operation for each sub-combination may include: sequentially traversing all the to-be-processed order groups in the sub-combination in different order group sequences, and, for each traversed to-be-processed order group, determining, from unmatched delivery persons, a delivery person with a highest matching degree with each to-be-processed order group to obtain M allocation lists, wherein M is an integer greater than or equal to 1; for each allocation list, calculating a sum of matching scores corresponding to all the to-be-processed order groups, to obtain a list score of each allocation list; and allocating each to-be-processed order group to a corresponding delivery person based on an allocation list with a highest list score.

A second aspect of the present disclosure is directed to an order group allocation apparatus. The apparatus may include a determining module, a division module, and an allocation module.

The determining module may be configured to determine, based on a matching score between each of a plurality of to-be-processed order groups and each of a plurality of delivery persons, a to-be-processed order group with a lowest matching score corresponding to each delivery person. The division module may be configured to divide the to-be-processed order groups and the delivery persons into a plurality of non-intersecting sub-combinations based on the to-be-processed order group with the lowest matching score corresponding to each delivery person. The “non-intersecting” means that there is no overlapping to-be-processed order groups and no overlapping delivery persons between the sub-combinations. The allocation module may be configured to allocate a to-be-processed order group based on an order group allocation process for each sub-combination, so that each to-be-processed order group in each sub-combination may be allocated to a delivery person in a corresponding sub-combination.

A third aspect of the present disclosure further is directed to an electronic device. The device may include one or more memories and one or more processors. The one or more memories may be configured to store one or more computer instructions. Upon being executed by the one or more processor, the one or more computer instructions may cause the one or more processors to perform the foregoing order group allocation method.

A fourth aspect of the present disclosure is directed to a computer-readable storage medium that stores a computer program. Upon being executed by a computer, the computer program may cause the computer to perform the foregoing order group allocation method.

In the embodiments of the present disclosure, a large quantity of order groups and delivery persons are divided into a plurality of non-intersecting sub-combinations using the traversal algorithm. The order group with the lowest matching score corresponding to each delivery person may be used as the constraint condition. There is no overlapping to-be-processed order groups and delivery persons within each of the sub-combinations, and quantities of order groups and delivery persons in each sub-combination are greatly reduced. Then, the maximum weight matching operation is used for each sub-combination, so that a to-be-processed order group in each sub-combination can be rapidly allocated to a delivery person in a corresponding sub-combination. Therefore, order group allocation efficiency can be greatly improved.

### BRIEF DESCRIPTION OF THE DRAWINGS

The accompanying drawings described herein are intended to provide a further understanding of the present disclosure, and constitute a part of the present disclosure. The illustrative embodiments of the present disclosure and descriptions thereof are intended to describe the present disclosure, and constitute no limitation on the present disclosure.

FIG. 1 is a schematic flowchart of an order group allocation method according to an embodiment of the present disclosure.

FIG. 2 is a schematic structural diagram of a network topology between an order group and a delivery person before division according to an embodiment of the present disclosure.

FIG. 3 is a schematic structural diagram of a network topology between an order group and a delivery person after division in a plurality of non-intersecting sub-networks according to an embodiment of the present disclosure.

FIG. 4 is a schematic structural diagram of an order group allocation apparatus according to an embodiment of the present disclosure.

FIG. 5 is a schematic structural diagram of an electronic device corresponding to an order group allocation apparatus according to an embodiment of the present disclosure.

### DETAIL DESCRIPTION OF THE EMBODIMENTS

To make the objectives, technical solutions, and advantages of the present disclosure clearer, the following clearly and completely describes the technical solutions of the present disclosure with reference to the specific embodiments of the present disclosure and the corresponding accompanying drawings. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

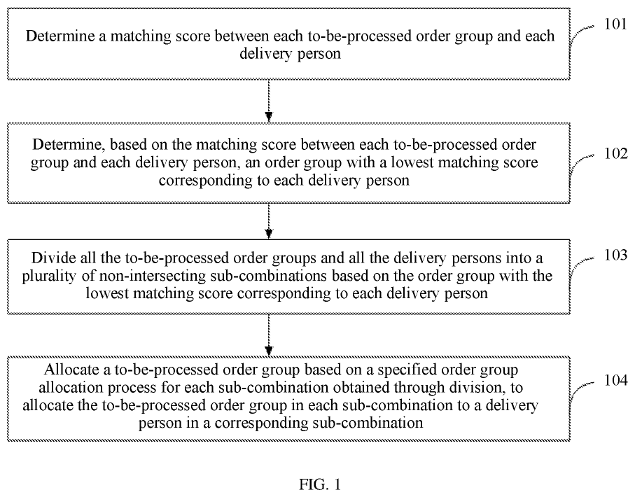

FIG. 1 is a schematic flowchart of an order group allocation method according to an embodiment of the present disclosure. As shown in FIG. 1, the method may include the following steps.

In step 101, a matching score between each to-be-processed order group and each delivery person may be determined.

In an optional embodiment, when a delivery indicator includes a start address, a destination address, and an expected completion time, and a status indicator includes an estimated delivery time and an estimated delivery location, allocating each to-be-processed order group to a matched delivery person based on the delivery indicator and the status indicator may include: calculating the matching score between each to-be-processed order group and each delivery person based on one or more factors of: a distance between an estimated delivery location of each delivery person and a start address of each to-be-processed order group, a time difference between an estimated delivery time of each delivery person and an expected arrival time of each to-be-processed order group, a degree of familiarity with the start address of each to-be-processed order group by each delivery person, a degree of familiarity with a destination address of each to-be-processed order group by each delivery person, an estimated completion time in which each delivery person completes delivery of each to-be-processed order group, and an emergency degree of each to-be-processed order group.

The degree of familiarity with the start address and the degree of familiarity with the destination address may be preset. Alternatively, a quantity of historical times that the delivery person arrived at the start address may be determined based on a historical delivery record of the delivery person, to determine the degree of familiarity with the start address. A larger quantity of historical times may indicate a higher degree of familiarity. Likewise, a quantity of historical times that the delivery person arrived at the destination address may be determined based on a historical delivery record of the delivery person, to determine the degree of familiarity with the destination address. A larger quantity of historical times indicates a higher degree of familiarity.

The emergency degree of the to-be-processed order group may be determined based on a corresponding delivery business. For example, a delivery business with a higher delivery timeliness requirement may have a higher emergency degree, and a delivery business with a lower delivery timeliness requirement may have a lower emergency degree. Alternatively, the emergency degree of the to-be-processed order group may be determined based on an expected completion time of the to-be-processed order group, and may be determined based on a time difference between a current moment and the expected completion time. A smaller time difference may indicate a higher emergency degree.

A sub-matching score of each factor may be calculated for each factor. Then, the matching score between each to-be-processed order group and each delivery person may be calculated by adding, taking a weighted sum of, or taking a weighted average of sub-matching scores of one or more factors.

For example, scores corresponding to different distance values may be preset. Thus, a corresponding score may be identified based on the distance between the estimated delivery location of each delivery person and the start address of each to-be-processed order group, and the score may be used as a first sub-matching score. For ease and clarity of description, “first”, “second”, “third”, and the like herein are used to distinguish between sub-matching scores of different factors.

Scores corresponding to different time difference values may be preset. Thus, a corresponding score may be identified based on the time difference between the estimated delivery time of each delivery person and the expected arrival time of each to-be-processed order group, and the score may be used as a second sub-matching score. A score corresponding to a time difference between the estimated completion time and a current time may be identified based on the estimated completion time in which each delivery person completes delivery of each to-be-processed order group, and the score may be used as a third sub-matching score.

Scores corresponding to different degrees of familiarity may be preset. Thus, a corresponding score may be identified based on the degree of familiarity with the start address of each to-be-processed order group by each delivery person, and the score may be used as a fourth sub-matching score. A corresponding score may be identified based on the degree of familiarity with the destination address of each to-be-processed order group, and the score may be used as a fifth sub-matching score.

Scores corresponding to different emergency degrees may be preset. Thus, a corresponding sixth sub-matching score may be identified based on the emergency degree of each to-be-processed order group.

The matching score between each to-be-processed order group and each delivery person may be determined based on the foregoing sub-matching scores.

In step 102, based on the matching score between each to-be-processed order group and each delivery person, an order group with a lowest matching score corresponding to each delivery person may be determined.

In step 103, the to-be-processed order groups and the delivery persons may be divided into a plurality of non-intersecting sub-combinations based on the order group with the lowest matching score corresponding to each delivery person. Here, “non-intersecting” means that there is no overlapping to-be-processed order groups and no overlapping delivery persons between the sub-combinations obtained through division.

For example, each order group and each delivery person may be traversed using a traversal algorithm, such as a breadth-first traversal algorithm or a depth-first traversal algorithm, and all the to-be-processed order groups and all the delivery persons may be divided into a plurality of non-intersecting sub-combinations by using the order group with the lowest matching score corresponding to each delivery person as a constraint condition.

The traversal algorithm such as the breadth-first traversal algorithm or the depth-first traversal algorithm may be an existing algorithm, and is not limited in the present invention. In this embodiment of the present invention, the traversal algorithm such as the breadth-first traversal algorithm or the depth-first traversal algorithm may be used in a scenario in which all the to-be-processed order groups and all the delivery persons are divided into a plurality of non-intersecting sub-combinations. Specific implementation may include the following steps.

First, a network topology may be established by using the to-be-processed order groups and the delivery persons as nodes. A link between each to-be-processed order group and each delivery person may represent a corresponding matching score.

Second, for each node, all associated nodes of the node may be traversed by using a lowest matching score between the nodes as a constraint condition, and an associated node with a lowest matching score may be determined, and a link between the node and the associated node with the lowest matching score may be deleted.

Third, the network topology may be divided into a plurality of non-intersecting sub-networks. There is no overlapping links in the plurality of non-intersecting sub-networks.

The plurality of non-intersecting sub-networks may be the corresponding plurality of non-intersecting sub-combinations.

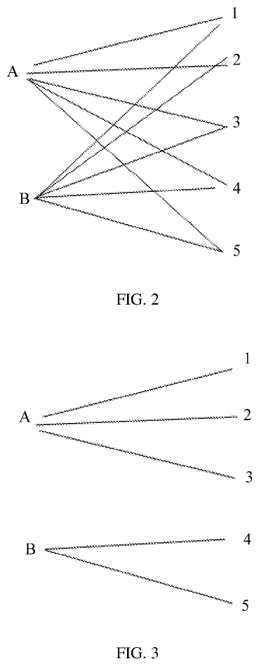

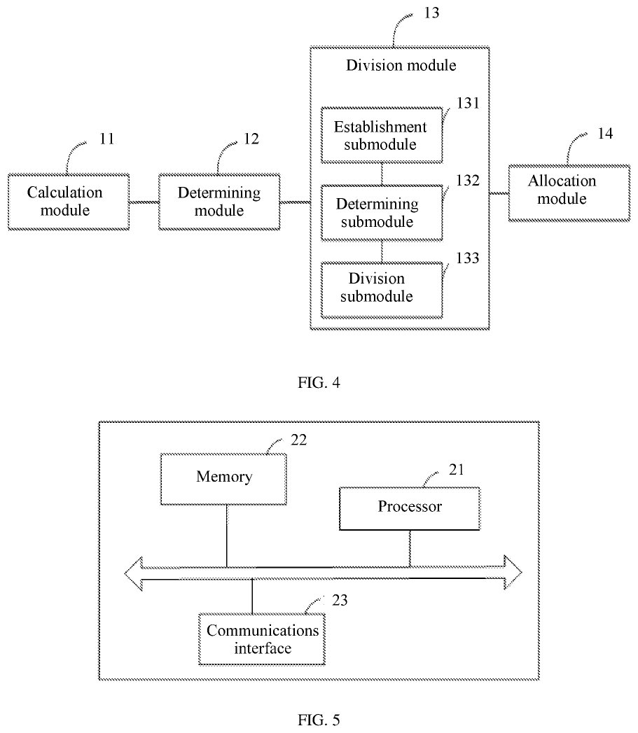

For example, assuming that there are five order groups marked as 1, 2, 3, 4, and 5, and two delivery persons marked as A and B, there is a matching score between each delivery person and each of the five order groups. FIG. 2 is a schematic structural diagram of a network topology between an order group and a delivery person before division according to an embodiment of the present disclosure. As shown in FIG. 2, each to-be-processed order group and each delivery person may be used as nodes in the network topology, and a link between the nodes may be established based on the matching score between each delivery person and each of the five order groups.

For each node, all the associated nodes of the node may be traversed by using the traversal algorithm such as the breadth-first traversal algorithm or the depth-first traversal algorithm. The lowest matching score between the nodes may be used as the constraint condition. For each node, an associated node with the lowest matching score may be determined, the link between the node and the associated node with the lowest matching score may be deleted, and the network topology may be divided into a plurality of non-intersecting sub-networks.

FIG. 3 is a schematic structural diagram of a network topology between an order group and a delivery person after the division of a plurality of non-intersecting sub-networks according to an embodiment of the present disclosure. As shown in FIG. 3, after each node is traversed, it is assumed that a matching score between A and 4 is the lowest, then a link between A and 4 may be deleted. It is assumed that a matching score between B and 3 is the lowest, then a link between B and 3 may be deleted. Thus, the network topology in FIG. 2 may be divided into two non-intersecting sub-networks, each sub-network corresponding to one sub-combination. There is no overlapping to-be-processed order groups and delivery persons between the two sub-combinations.

In step 104, a to-be-processed order group may be allocated based on an order group allocation process for each sub-combination obtained through the division, so that the to-be-processed order group in each sub-combination may be allocated to a delivery person in a corresponding sub-combination.

For each sub-combination obtained through division, a maximum weight matching operation may be performed on each to-be-processed order group and each delivery person in each sub-combination, to determine a delivery person with a highest matching score corresponding to each to-be-processed order group. The maximum weight matching operation for each sub-combination may include the following step.

First, all the to-be-processed order groups in the sub-combination may be sequentially traversed in different order group sequences. For each traversed to-be-processed order group, a delivery person with a highest matching degree with each to-be-processed order group may be determined from unmatched delivery persons to obtain M allocation lists. M is an integer greater than or equal to 1.

Second, for each allocation list, a sum of matching scores corresponding to all the to-be-processed order groups may be calculated to obtain a list score of each allocation list.

Third, each to-be-processed order group may be allocated to a corresponding delivery person based on an allocation list with a highest list score.

For ease of understanding, the following example is used for description.

Assuming that a sub-combination includes two to-be-processed order groups A and B and three delivery persons X, Y, and Z, a matching score between each to-be-processed order group and each of the three delivery person may be calculated. It is assumed that a matching score between A and X is P_{AX}, a matching score between A and Y is P_{AY}, a matching score between A and Z is P_{AZ}, a matching score between B and X is PBX, a matching score between B and Y is P_{BY}, and a matching score between B and Z is P_{BZ}.

A is used as the first to-be-determined unallocated order group, and a delivery person with a highest matching degree is selected from X, Y, and Z based on the matching scores P_{AX}, P_{AY}, and P_{AZ}. It is assumed that the delivery person with the highest matching degree is X corresponding to P_{AX}. B is used as the second to-be-determined unallocated order group. Because X has been selected for A, a delivery person with a higher matching degree is selected for B from unmatched Y and Z. It is assumed that the delivery person with the higher matching degree is Z corresponding to P_{BZ}. In this case, an obtained allocation list is that A is allocated to X and B is allocated to Z. A sum of the matching scores P_{AX} and P_{BZ} is calculated. It is assumed that the sum is R1, which may be used as a list score of the allocation list.

By analogy, A is used as the second to-be-determined unallocated order group, and B is used as the first to-be-determined unallocated order group. It is assumed that an obtained allocation list is that A is allocated to Y and B is allocated to X. A sum of the matching scores P_{AY} and P_{BZ} is calculated. It is assumed that the sum is R2, which may be used as a list score of the allocation list.

It can be learned from the foregoing description that, when A is used as the first to-be-determined unallocated order group, the delivery person X with the highest matching degree is preferably selected for A from X, Y, and Z. Because B is the second to-be-determined unallocated order group, the delivery person Z with the higher matching degree can be selected only from Y and Z. When B is used as the first to-be-determined unallocated order group, the delivery person X with the highest matching degree may be preferably selected for B from X, Y, and Z, and the delivery person Y with the higher matching degree can be selected for A only from Y and Z. Therefore, when A and B are separately used as an i^{th} to-be-determined unallocated order group, different allocation lists may be obtained, wherein i ranges from 1 to N, and N is a total quantity of order groups in a sub-combination.

An allocation list with an optimal list score may be determined by comparing R1 and R2. It is assumed that R2 is the allocation list with the optimal list score. In this case, allocation is performed based on the allocation list corresponding to R2, that is, A is allocated to Y and B is allocated to X.

If a higher matching score indicates a higher matching degree, a higher list score indicates a more optimal list score. On the contrary, if a lower matching score indicates a higher matching degree, a lower list score indicates a more optimal list score.

In some cases, there may be no delivery person that can match a to-be-processed order group. For example, when a quantity of to-be-processed order groups is greater than a quantity of delivery persons, and if only one to-be-processed order group can be allocated to each delivery person, one or more to-be-processed order groups may remain un-allocated. In this case, the method may return back to step 101 to continue to perform the next order group scheduling.

According to the order group allocation method provided in this embodiment, a large quantity of order groups and delivery persons are divided into a plurality of non-intersecting sub-combinations by using the traversal algorithm. The order group with the lowest matching score corresponding to each delivery person may be used as the constraint condition, and there is no overlapping to-be-processed order groups and delivery persons between the sub-combinations. Quantities of order groups and delivery persons in each sub-combination may be greatly reduced. Then, the maximum weight matching operation may be performed for each sub-combination, so that a to-be-processed order group in each sub-combination can be rapidly allocated to a delivery person in a corresponding sub-combination. Therefore, order group allocation efficiency can be greatly improved.

FIG. 3 is a schematic structural diagram of an order group allocation apparatus according to another embodiment of the present disclosure. As shown in FIG. 3, the apparatus may include a calculation module 11, a determining module 12, a division module 13, and an allocation module 14.

The calculation module 11 may be configured to calculate a matching score between each to-be-processed order group and each delivery person based on one or more factors of a distance between an estimated delivery location of each delivery person and a start address of each to-be-processed order group, a time difference between an estimated delivery time of each delivery person and an expected arrival time of each to-be-processed order group, a degree of familiarity with the start address of each to-be-processed order group by each delivery person, a degree of familiarity with a destination address of each to-be-processed order group by each delivery person, an estimated completion time in which each delivery person completes delivery of each to-be-processed order group, and an emergency degree of each to-be-processed order group.

The determining module 12 may be configured to determine, based on the matching score between each to-be-processed order group and each delivery person, an order group with a lowest matching score corresponding to each delivery person.

The division module 13 may be configured to divide all the to-be-processed order groups and all the delivery persons into a plurality of non-intersecting sub-combinations based on the order group with the lowest matching score corresponding to each delivery person. Here, “non-intersecting” means that there is no overlapping to-be-processed order groups and no overlapping delivery persons between the sub-combinations obtained through division.

The allocation module 14 may be configured to allocate a to-be-processed order group based on an order group allocation process for each sub-combination obtained through division, so that the to-be-processed order group in each sub-combination may be allocated to a delivery person in a corresponding sub-combination.

Optionally, the division module 13 may be configured to: traverse each order group and each delivery person by using a traversal algorithm, and divide all the to-be-processed order groups and all the delivery persons into a plurality of non-intersecting sub-combinations by using the order group with the lowest matching score corresponding to each delivery person as a constraint condition. The traversal algorithm may include a breadth-first traversal algorithm or a depth-first traversal algorithm.

Optionally, the division module 13 may include an establishment submodule 131, a determining submodule 132, and a division submodule 133.

The establishing submodule 131 may be configured to establish a network topology by using the to-be-processed order groups and the delivery persons as nodes. A link between each to-be-processed order group and each delivery person may represent a corresponding matching score.

The determining submodule 132 may be configured to: for each node, traverse all associated nodes of the node by using a lowest matching score between the nodes as a constraint condition. For each node, determine an associated node with a lowest matching score, and delete a link between the node and the associated node with the lowest matching score.

The division submodule 133 may be configured to divide the network topology into a plurality of non-intersecting sub-networks. There is no overlapping links in the plurality of non-intersecting sub-networks, and the plurality of non-intersecting sub-networks may be the corresponding plurality of non-intersecting sub-combinations.

Optionally, the allocation module 14 may be configured to: for each sub-combination obtained through division, perform a maximum weight matching operation on each to-be-processed order group and each delivery person in each sub-combination, to determine a delivery person with a highest matching score corresponding to each to-be-processed order group.

The maximum weight matching operation for each sub-combination includes: sequentially traversing all the to-be-processed order groups in the sub-combination in different order group sequences, and, for each traversed to-be-processed order group, determining a delivery person with a highest matching degree with each to-be-processed order group from unmatched delivery persons to obtain M allocation lists. M is an integer greater than or equal to 1; for each allocation list, calculating a sum of matching scores corresponding to all the to-be-processed order groups to obtain a list score of each allocation list; and allocating each to-be-processed order group to a corresponding delivery person based on an allocation list with a highest list score.

The order group allocation apparatus provided in this embodiment may be configured to execute the foregoing order group allocation method. Execution logic thereof is not described again. Related descriptions in the method embodiment may be referred to for details.

The apparatus embodiment described above is only an example. The submodules described as discrete parts may be physically separated or not, and parts displayed as submodules may be physical submodules or not, may be located in one place or distributed on a plurality of network submodules. Some or all of the modules may be selected based on an actual need to achieve the objectives of the solutions of the embodiments. A person of ordinary skill in the art can understand and implement the solutions without creative efforts.

The foregoing describes an internal function and structure of the order group allocation apparatus. In a possible design, the structure of the order group allocation apparatus may be implemented as an electronic device. The electronic device may be, for example, a server. As shown in FIG. 5, the electronic device may include a processor 21 and a memory 22. The memory 22 may be configured to store a program that supports the order group allocation apparatus in performing the order group allocation method provided in any one of the foregoing embodiments. The processor 21 may be configured to execute the program stored in the memory 22.

The program may include one or more computer instructions. Upon being executed by the processor 21, the one or more computer instructions may cause the processor 21 to perform the following steps: determining, based on a matching score between each of a plurality of to-be-processed order groups and each of a plurality of delivery persons, an order group with a lowest matching score corresponding to each delivery person; dividing all the to-be-processed order groups and all the delivery persons into a plurality of non-intersecting sub-combinations based on the order group with the lowest matching score corresponding to each delivery person, wherein “non-intersecting” means that there is no overlapping to-be-processed order groups and no overlapping delivery persons between the sub-combinations obtained through division; and allocating a to-be-processed order group based on an order group allocation process for each sub-combination obtained through division, so that the to-be-processed order group in each sub-combination may be allocated to a delivery person in a corresponding sub-combination.

Optionally, the processor 21 may be further configured to perform all or some of the foregoing steps.

The structure of the order group allocation apparatus may further include a communications interface 23 used by the order group allocation apparatus to communicate with another device or a communications network.

In addition, an embodiment of the present invention provides a computer storage medium, configured to store a computer software instruction used by the order group allocation apparatus. The computer software instruction may include a related program used to perform the order group allocation method in the method embodiments.

A person skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or the block diagrams of the method, the device (system), and the computer program product according to the embodiments of the present invention. It should be understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specified function in one or more processes in the flowcharts and/or in one or more blocks in the block diagrams.

These computer program instructions may be stored in a computer-readable memory that can instruct a computer or another programmable data processing device to work in a specific manner, so that the instructions stored in the computer-readable memory generate an artifact that includes an instruction apparatus. The instruction apparatus implements a specified function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specified function in one or more processes in the flowcharts and/or in one or more blocks in the block diagrams.

In a typical configuration, a computing device includes one or more central processing units (CPU), an input/output interface, a network interface, and a memory.

The memory may include a non-persistent memory, a random access memory (RAM), and/or a non-volatile memory, or other forms of computer-readable media, such as a read-only memory (ROM) or a flash memory (flash RAM). The memories are merely examples of the computer-readable media.

The computer-readable media include persistent, non-persistent, removable, and non-removable media in which information can be stored by using any method or technology. The information may be computer-readable instructions, data structures, program modules, or other data. Examples of the computer storage media include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette tape, a magnetic tape or a disk storage, another magnetic storage device, or any other non-transmission media that can be used to store information accessible to a computing device. As defined in this specification, the computer-readable media do not include computer-readable transitory media (transitory media), such as modulated data signals and carriers.

It should be further noted that the term “include”, “contain”, or any other variant thereof is intended to cover a non-exclusive inclusion, so that a process, a method, an article, or a device that includes a series of elements not only includes those elements, but also includes other elements that are not expressly listed, or further includes elements inherent to the process, method, article, or device. An element preceded by “includes a . . . ” does not, without more constraints, preclude the existence of additional identical elements in the process, method, article, or device that includes the elements.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

The foregoing descriptions are merely the embodiments of the present disclosure, but are not intended to limit the present disclosure. A person skilled in the art may make various medications and changes to the present disclosure. Any modification, equivalent replacement, or improvement made without departing from the spirit and principle of the present disclosure shall fall within the claims of the present disclosure.

What is claimed is:

1. An order group allocation method, comprising:
determining, based on a matching score between each of a plurality of to-be-processed order groups and each of a plurality of delivery persons, a to-be-processed order group with a lowest matching score corresponding to each delivery person;
dividing, based on the to-be-processed order group with the lowest matching score corresponding to each delivery person, the to-be-processed order groups and the delivery persons into a plurality of non-intersecting sub-combinations, wherein “non-intersecting” means that there is no overlapping to-be-processed order groups and no overlapping delivery persons between the sub-combinations; and
allocating, based on an order group allocation process for each sub-combination, the to-be-processed order groups, so that each to-be-processed order group in each sub-combination is allocated to a delivery person in a corresponding sub-combination.

2. The method of claim 1, further comprising:
calculating the matching score between each to-be-processed order group and each delivery person based on one or more factors of a distance between an estimated delivery location of each delivery person and a start address of each to-be-processed order group, a time difference between an estimated delivery time of each delivery person and an expected arrival time of each to-be-processed order group, a degree of familiarity with the start address of each to-be-processed order group by each delivery person, a degree of familiarity with a destination address of each to-be-processed order group by each delivery person, an estimated completion time in which each delivery person completes delivery of each to-be-processed order group, and an emergency degree of each to-be-processed order group.

3. The method of claim 1, wherein dividing the to-be-processed order groups and the delivery persons into a plurality of non-intersecting sub-combinations comprises:
traversing, using a traversal algorithm, each to-be-processed order group and each delivery person, and dividing, using the to-be-processed order group with the lowest matching score corresponding to each delivery person as a constraint condition, the to-be-processed order groups and the delivery persons into a plurality of non-intersecting sub-combinations,
wherein the traversal algorithm comprises a breadth-first traversal algorithm or a depth-first traversal algorithm.

4. The method of claim 3, wherein traversing, using a traversal algorithm, each to-be-processed order group and each delivery person, and dividing, using the to-be-processed order group with the lowest matching score corresponding to each delivery person as a constraint condition, the to-be-processed order groups and the delivery persons into a plurality of non-intersecting sub-combinations comprises:
establishing, using the to-be-processed order groups and the delivery persons as nodes, a network topology, wherein a link between each to-be-processed order group and each delivery person represents a corresponding matching score;
traversing, using a lowest matching score between the nodes as a constraint condition, all associated nodes of each node, determining, for each node, an associated node with a lowest matching score, and deleting, for each node, a link between the node and the associated node with the lowest matching score; and
dividing the network topology into a plurality of non-intersecting sub-networks, wherein there is no overlapping links in the plurality of non-intersecting sub-networks,
wherein the plurality of non-intersecting sub-networks are the corresponding plurality of non-intersecting sub-combinations.

5. The method of claim 1, wherein allocating, based on an order group allocation process for each sub-combination, the to-be-processed order groups, so that each to-be-processed order group in each sub-combination is allocated to a delivery person in a corresponding sub-combination comprises:
performing, for each sub-combination, a maximum weight matching operation on each to-be-processed order group and each delivery person in each sub-combination to determine a delivery person with a highest matching score corresponding to each to-be-processed order group,
wherein the maximum weight matching operation comprises:
sequentially traversing all the to-be-processed order groups in the sub-combination in different order group sequences, and for each traversed to-be-processed order group, determining, from unmatched delivery persons, a delivery person with a highest matching degree with each to-be-processed order group to obtain M allocation lists, wherein M is an integer greater than or equal to 1;
calculating, for each allocation list, a sum of matching scores corresponding to all the to-be-processed order groups to obtain a list score of each allocation list; and
allocating, based on an allocation list with a highest list score, each to-be-processed order group to a corresponding delivery person.

6. An order group allocation apparatus, comprising:
a determining module, configured to determine, based on a matching score between each of a plurality to-be-processed order groups and each of a plurality delivery persons, a to-be-processed order group with a lowest matching score corresponding to each delivery person;
a division module, configured to divide, based on the to-be-processed order group with the lowest matching score corresponding to each delivery person, the to-be-processed order groups and the delivery persons into a plurality of non-intersecting sub-combinations, wherein “non-intersecting” means that there is no overlapping to-be-processed order groups and no overlapping delivery persons between the sub-combinations; and
an allocation module, configured to allocate, based on an order group allocation process for each sub-combination, the to-be-processed order groups, so that each to-be-processed order group in each sub-combination is allocated to a delivery person in a corresponding sub-combination.

7. The apparatus of claim 6, further comprising:
a calculation module, configured to calculate the matching score between each to-be-processed order group and each delivery person based on one or more factors of a distance between an estimated delivery location of each delivery person and a start address of each to-be-processed order group, a time difference between an estimated delivery time of each delivery person and an expected arrival time of each to-be-processed order group, a degree of familiarity with the start address of each to-be-processed order group by each delivery person, a degree of familiarity with a destination address of each to-be-processed order group by each delivery person, an estimated completion time in which each delivery person completes delivery of each to-be-processed order group, and an emergency degree of each to-be-processed order group.

8. The apparatus of claim 6, wherein the division module is configured to:
traverse, using a traversal algorithm, each to-be-processed order group and each delivery person, and divide, using the to-be-processed order group with the lowest matching score corresponding to each delivery person as a constraint condition, the to-be-processed order groups and the delivery persons into a plurality of non-intersecting sub-combinations,
wherein the traversal algorithm comprises a breadth-first traversal algorithm or a depth-first traversal algorithm.

9. The apparatus of claim 8, wherein the division module comprises:
an establishing submodule, configured to establish, using the to-be-processed order groups and the delivery persons as nodes, a network topology, wherein a link between each to-be-processed order group and each delivery person represents a corresponding matching score;
a determining submodule, configured to traverse, using a lowest matching score between the nodes as a constraint condition, all associated nodes of each node, determine, for each node, an associated node with a lowest matching score, and delete, for each node, a link between the node and the associated node with the lowest matching score; and
a division submodule, configured to divide the network topology into a plurality of non-intersecting sub-networks, wherein there is no overlapping links in the plurality of non-intersecting sub-networks, and the plurality of non-intersecting sub-networks are the corresponding plurality of non-intersecting sub-combinations.

10. The apparatus of claim 6, wherein the allocation module is configured to:
perform, for each sub-combination, a maximum weight matching operation on each to-be-processed order group and each delivery person in each sub-combination to determine a delivery person with a highest matching score corresponding to each to-be-processed order group,
wherein the maximum weight matching operation comprises:
sequentially traversing all the to-be-processed order groups in the sub-combination in different order group sequences, and for each traversed to-be-processed order group, determining, from unmatched delivery persons, a delivery person with a highest matching degree with each to-be-processed order group, to obtain M allocation lists, wherein M is an integer greater than or equal to 1;
calculating, for each allocation list, a sum of matching scores corresponding to all the to-be-processed order groups, to obtain a list score of each allocation list; and
allocating, based on an allocation list with a highest list score, each to-be-processed order group to a corresponding delivery person.

11. An electronic device, comprising one or more memories and one or more processors, wherein the one or more memories are configured to store one or more computer instructions, and wherein upon being executed by the one or more processors, the one or more computer instructions cause the one or more processors to perform the method of claim 1.

12. A computer-readable storage medium that stores a computer program, wherein upon being executed by a computer, the computer program causes the computer to perform the method of claim 1.
